(19) United States
(12) Patent Application Publication
(10) Pub. No.: US 2025/0355889 A1
(43) Pub. Date: Nov. 20, 2025

(54) SIMPLIFYING AND OPTIMIZING DATA LINEAGE

(71) Applicant: Microsoft Technology Licensing, LLC, Redmond, WA (US)

(72) Inventors: Venkata SUBRAMANIAM, Redmond, WA (US); FNU HARKIRAT SINGH, Happy Valley, OR (US); Ashis Kumar ROY, Redmond, WA (US)

(73) Assignee: Microsoft Technology Licensing, LLC, Redmond, WA (US)

(21) Appl. No.: 18/665,071

(22) Filed: May 15, 2024

(51) Int. Cl. G06F 16/25

(52) U.S. Cl. CPC G06F 16/254

(57) ABSTRACT

According to examples, data lineage optimization of a dataset involves simplifying and optimizing the data lineage by executing a simplification process and an alteration process. The simplification and alteration processes can be executed iteratively on the datasets of a data lake either serially or parallelly. The simplification process optimizes the data pipeline by identifying and removing redundant data operations and simplifies data lineage graphs of datasets in the data lake. The alteration process improves the quality metrics of the datasets by identifying alternate transformations for generating the datasets such that the alternate transformations have higher quality metrics than the original transformations that created the datasets.

### BACKGROUND

Big data solutions depend on data pipelines to ingest, process, and transform large volumes of data from various sources. The term ‘big data’ implies that there is a large volume of data to be moved, transformed, or otherwise processed. Accordingly, data pipelines have been developed to support big data. Data pipelines include a set of processes that are designed to move data efficiently from one data repository to another. Data pipelines ingest raw data from various sources and transform and port the processed data to a data store. Data generated by one data source, e.g., an application or a database, may feed multiple downstream data pipelines, and those pipelines may yet feed multiple other pipelines or applications. A data pipeline supports data of different data formats such as structured, unstructured, and semi-structured data. If designed properly, data pipelines enable seamless flow of information across various stages of data processing. However, complex data pipelines can face performance, efficiency, and quality issues due to multiple stages and operations involved.

### BRIEF DESCRIPTION OF DRAWINGS

Features of the present disclosure are illustrated by way of examples shown in the following figures. In the following figures, like numerals indicate like elements, in which:

FIG. 1A shows a block diagram of a data pipeline optimizer apparatus in accordance with an embodiment of the present disclosure.

FIG. 1B shows data lineage graphs that represent changes to the data lineage of a dataset in accordance with an embodiment of the present disclosure.

FIG. 1C shows a data lineage graph of a dataset on which an alteration process is implemented in accordance with an embodiment of the present disclosure.

FIG. 2 shows a flowchart of a simplification process for simplifying the data lineage graphs in accordance with an embodiment of the present disclosure.

FIG. 3 shows a flowchart of an alteration process of identifying alternate data paths/transformations in accordance with an embodiment of the present disclosure.

FIG. 4A shows an illustration of a portion of a representation of the various datasets in a data lake in accordance with an embodiment of the present disclosure.

FIG. 4B shows an example data lineage graph of a dataset in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are outlined to provide an understanding of the embodiments and examples. It will be apparent, however, to one of ordinary skill in the art, that the embodiments and examples may be practiced without limitation to these specific details. In some instances, well-known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to.

Given the performance issues facing complex data pipelines as described above, a data lineage optimizer apparatus is disclosed herein for the simplification and optimization of data pipelines using data lineage graphs and query plan evaluation along with various metrics. The various metrics may include quality, reliability, complexity of transforms applied at the nodes in the data lineage graphs, and/or the like. As discussed herein, data lineage graphs may show the flow and transformation of data from one system to another, and captures the complexity and dependencies of the data flow. In addition, data lineage may be defined as the process of tracking the history of a data value v (denoted as lineage (v)) over time and may provide a clear understanding of where the data originated, how the data has changed, and the ultimate destination of the data within the data pipeline.

The lineage of data d may be represented as a labeled, directed acyclic graph that shows the previous data values and operations that produced data d. The data values are the nodes of the labeled, directed acyclic graph (denoted as a process(lineage (d))), and the operations are the labeled edges of the graph. Data lineage provides a record of data throughout its lifecycle, including source information and any data transformations that have been applied during any Extract, Transform, Load (ETL) or Extract, Load, Transform (ELT) processes.

Query plans show the logical and physical operations of each processing step, capturing the cost and feasibility of the operations. A query plan is a specification of the operations that the database management system performs to execute a query over the data d. The query job translates the declarative Structured Query Language (SQL) statement into an execution graph including a hierarchy of query stages represented by an abstract syntax tree (AST). Each query stage includes a set of fine-grained execution primitives.

According to examples, the lineage of data d can be viewed as a combined execution graph that integrates the information from both the data lineage graph and the execution graph. The data lineage graph captures the provenance and the processing of data d from its source to its query result. The data lineage optimization apparatus disclosed herein analyzes the data lineage graphs to determine the data flow and analyzes the query plans to identify the operations. Based on this analysis, the data lineage optimization apparatus disclosed herein identifies opportunities for optimization, such as removing redundant or unnecessary operations, combining compatible or similar steps, simplifying the overall data landscape, and/or the like.

The data lineage optimization apparatus disclosed herein includes a processor and a memory on which are stored machine-readable instructions that when executed by the processor cause the processor to optimize data pipelines via execution of at least a simplification process and an alteration process of different datasets of a data repository such as a data lake. A data lake may be defined as a centralized repository for storing, processing, and securing large amounts of structured, semi-structured, or unstructured datasets. The data lake includes different types of datasets such as but not limited to, source datasets, intermediate datasets, destination datasets, and final datasets. Source datasets are datasets that are not derived from other data sources but which may be used to generate downstream datasets. Destination datasets are intermediate datasets that are derived from other source datasets but may also have other downstream dependencies. Final datasets are datasets from which no further datasets are derived or datasets on which there are no dependencies. Hence, final datasets may be represented by leaf nodes or terminal nodes of the data lineage graphs.

According to examples, the processor selects certain data lineage graphs of processes exhibiting lower quality metrics (e.g., based on pre-configured quality metrics thresholds) for optimization. In an example, the processor can alternatively or additionally select data lineage graphs of processes via scheduled routines for optimization. The final dataset represented by the terminal node of the data lineage graph is initially selected for column processing via one or more of the simplification process or the alteration process. The simplification process removes redundant data operations and simplifies the data lineage graph of the selected dataset. The alteration process identifies an alternate transformation that transforms an original dataset into a final dataset so that the alternate transformation has superior quality metrics than an original transformation that is currently in use for transforming the original data set to the final dataset. The alteration process can be serially executed on the same dataset on which the simplification process was executed in an example. In another example, the alteration process can be parallelly executed on other final datasets of the data lake.

In some examples, the processor iteratively executes the simplification process and the alteration process on the datasets of the data lake so that the quality and efficiency of the database system are maintained. On completing the execution of one or more of the simplification process and the alteration process, the processor generates new abstract syntax trees (ASTs) which are further translated into executable code that modifies, for example, one or more of the ETL or ELT processes for the data lake.

To execute the simplification process, the processor iteratively calculates a transform complexity of the transformations used to generate the columns of a selected or target dataset. The processor also iteratively extracts the dependencies of the column from an abstract syntax tree (AST) of the transformation. The processor continues the calculation of the transform complexity and the extraction of dependencies for a plurality of other columns of the target dataset until a sum of the transform complexities of at least a subset of the plurality of columns exceeds a transform complexity threshold. The processor identifies one of the datasets of the data lake processed in a step immediately preceding the sum of the transform complexities exceeding the transform complexity threshold as a source dataset for directly receiving the dependency of the target dataset.

To execute the alteration process that identifies the alternate transformation, the processor extracts quality metrics of data generated by an original transformation and the data resulting from the alternate transformation. Quality is a function of various factors such as but not limited to, the quality checks performed on the data before the transformation is published, the service level agreement the data/column guarantees, and the frequency of fulfillment of the service level agreement. The quality metrics of a column can be obtained from an upstream source. The processor generates the statistical column metrics vectors for the final dataset, and other datasets including the original dataset of the data lake, and calculates similarities between the statistical column metrics vector of the final dataset and the statistical column metrics vectors of other datasets including the original dataset of the data lake. Based at least on the abstract syntax trees (ASTs) of the original transformation, the processor identifies column dependencies of the final dataset. The processor selects a transformation that maximizes the similarities and improves on the quality metrics of the original transformation as the alternate transformation.

A common problem that exists is that data users tend to use readily available or accessible data without verifying if there is an upstream data source that is closer to the data origin and may therefore be more suitable and efficient. This results in a tangled data lineage and inefficient data processes. Embodiments of the data pipeline optimization disclosed herein enable the selection of the optimal and shortest data path to produce the desired end data product, given the overall data landscape in the form of data lineage graphs. In these days of big data, organizations have high data volumes that need to be managed well. Good data management should ensure that the data is reliable, follows the rules, and does what the data is supposed to do. Data lineage optimization disclosed herein can help organizations work better by fixing problems with the data, getting rid of redundant data, and making the data easier to use and share. The disclosed embodiments of data lineage optimization address the aforementioned technical challenges of reduced efficiency of quality of data systems that arise from complex data lineages by enabling the removal of redundant data products and reducing the number of steps between the data source and the data product, which can improve data quality and cost-effectiveness.

Reducing the number of steps between the data source and the data product involves a determination of not only the provenance of each column in the dataset but also the transformation that the data undergoes along its journey. Getting closer to the data source could also entail taking over the complex transformation and business logic being implemented and maintained upstream. Such a takeover can induce inefficiencies since the downstream personnel are not acquainted with the business logic, nor are the downstream personnel subject matter experts, and cannot keep the business logic updated with changing business intents and requirements. The implementation of the simplifying process captures the transformation that a column undergoes downstream using the data linage graph, discards redundant steps, but retains steps to be managed upstream for columns that have complex business logic that are deemed significant by leveraging the query plans available at each step during the transformation journey.

Another important consideration in simplifying the data lineage is assessing the quality of the data and the columns generated by the upstream sources. Often, getting closer to the source of the data entails choosing among different paths to reach the source that has similar transformations with vastly different quality metrics. Again, the alteration process implemented by the data lineage optimizing system disclosed herein extracts the various metrics published by each upstream source and then attempts to produce an optimal path and plan to generate the various columns within a dataset.

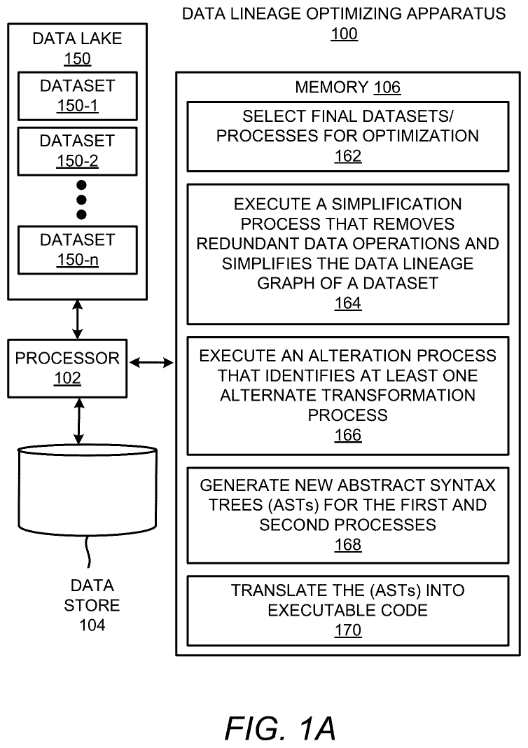

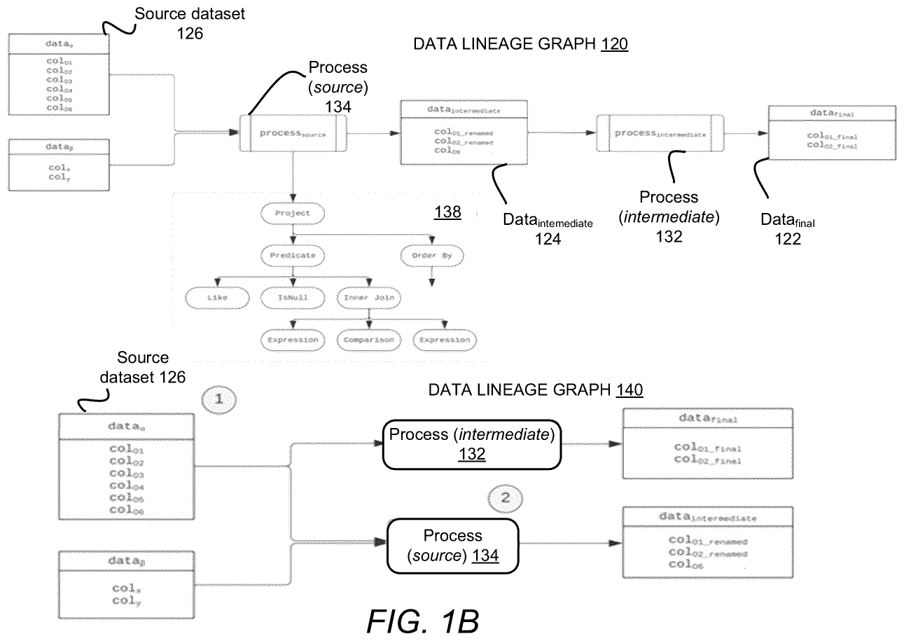

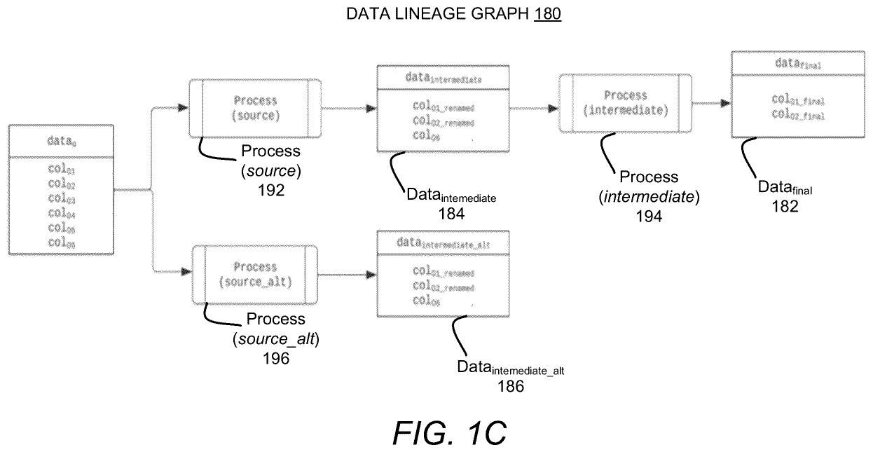

FIG. 1A shows a block diagram of a data lineage optimizing apparatus 100 in accordance with an embodiment of the present disclosure. The data lineage optimizing apparatus 100 includes a processor 102, a data store 104, and a memory 106. The memory 106 has stored thereon machine-readable instructions 162-170 that the processor 102 is to execute. Although the instructions 162-170 are described herein as being stored on the memory 106 and thus include a set of machine-readable instructions, the data lineage optimizing apparatus 100 may include hardware logic blocks that may perform functions similar to the instructions 162-170. For instance, the processor 102 may include hardware components that may execute the instructions 162-170. In other examples, the data lineage optimizing apparatus 100 may include a combination of instructions and hardware logic blocks as shown in FIG. 1A to implement or execute functions corresponding to the instructions 162-170. In any of these examples, the processor 102 may implement the hardware logic blocks and/or execute the instructions 162-170. As discussed herein, the data lineage optimizing apparatus 100 may also include additional instructions and/or hardware logic blocks such that the processor 102 may execute operations in addition to or in place of those discussed above with respect to FIG. 1A.

The processor 102 is a semiconductor-based microprocessor, a central processing unit (CPU), an application-specific integrated circuit (ASIC), a field-programmable gate array (FPGA), and/or other may be termed a computer-readable medium and is, for example, a Random Access memory (RAM), an Electrically Erasable Programmable Read-Only Memory (EEPROM), a storage device, or the like. In some examples, the memory 106 is a non-transitory computer-readable storage medium, where the term “non-transitory” does not encompass transitory propagating signals. In any regard, the memory 106 has stored thereon machine-readable instructions executable by the processor 102. Similarly, the data store 104 may be a Random Access Memory (RAM), an Electrically Erasable Programmable Read-Only Memory (EEPROM), a storage device, or the like.

Although the data lineage optimizing apparatus 100 is depicted as having a single processor it should be understood that the data lineage optimizing apparatus 100 may include additional processors and/or cores without departing from the scope of the data lineage optimizing apparatus 100. In this regard, references to a single processor 102, as well as to a single memory 106, may be understood to additionally or alternatively pertain to multiple processors 102, multiple memories 106, and/or data stores 104. In addition, or alternatively, the processor 102 and the memory 106 may be integrated into a single component, e.g., an integrated circuit on which both the processor 102 and the memory 106 may be provided. In addition, or alternatively, the operations described herein as being performed by the processor 102 can be distributed across multiple corresponding apparatuses and/or multiple processors.

The data lineage optimizing apparatus 100 can be communicatively coupled to a data lake 150 that includes a plurality of datasets, e.g., dataset 150-1, dataset 150-2, . . . dataset 150-n, in which n is a natural number and n=1, 2, 3, 4 . . . . The data lake 150 can store the datasets 150-1, . . . , 150-n in native formats and implements different data pipelines for data processing. The data lineage optimizing apparatus 100 is configured to simplify and optimize data pipelines using data lineage graphs and query plan evaluation along with various metrics such as but not limited to quality, reliability, and complexity of transforms applied at the nodes in the data lineage graphs.

The processes implemented by the data lineage optimizing apparatus 100 are described below with reference to FIGS. 1B and 1C. FIG. 1B illustrates optimizing the data lineage of a final dataset, e.g., dataset_{final} in accordance with an example disclosed herein. FIG. 1C illustrates identifying an alternate data path to produce the final dataset, e.g., dataset_{final} in accordance with an example disclosed herein.

The data lineage optimizing apparatus 100 executes processes to select the optimal path including one or more data transformations that maximize quality metrics while minimizing the time to produce desired end data products given the overall data landscape for a given organization in the form of data lineage graphs. Accordingly, the data lineage optimizing apparatus 100 executes instructions 162 to select datasets for optimization. The simplification and optimization processes to simplify data lineage graphs and identify optimal paths are iteratively executed on the selected datasets to improve the accuracy of results generated using the datasets while minimizing redundancies. The processes can be executed parallelly on different datasets or the processes can be executed serially on the same dataset one after another.

In particular, the processor 102 executes instructions 162 to select final datasets or destination datasets from the plurality of datasets 150-1, 150-2, . . . , 150-n of the data lake 150. Final datasets can be identified, for example, as the datasets represented by leaf nodes of data lineage graphs. For example, the processor 102 may select certain datasets from which further datasets are derived for optimization for reasons such as but not limited to inaccuracies in results, etc. The processor 102 may be triggered for the dataset selection process due to different reasons. One reason includes the results from certain datasets falling below preconfigured quality metrics thresholds. Another reason can include that the processor 102 is configured to execute the processes periodically.

The apparatus 100 executes instructions 164 to execute a simplification process to remove redundant data operations and simplify the data lineage graphs of final datasets. For example, FIG. 1B shows an initial data lineage graph 120 representing the lineage of the dataset the data_{final} 122, referred to as lineage(data_{final}). The lineage(data_{final}) includes another dataset as an intermediate dataset, data_{intermediate} 124. The intermediate dataset, e.g., data_{intermediate} 124, is generated through a source process represented as process(source) 134, which relies on source dataset 126 dataₐ with columns [01-06]. It is assumed in this scenario that process(source) 134 has simple transformations that do not involve any complex business logic whereas process(intermediate) 132 involves complex logic.

By examining the data lineage graph 120 and the query plan at each stage, the data lineage optimizing apparatus 100 can generate suggestions to reduce the complexity of the graph. For example, by accessing and analyzing the query plan (not shown) the instructions 164 can re-configure the process(intermediate) 132 to directly depend on the source dataset 126, instead of using the data_{intermediate} 124. The reduction of the data lineage graph 120 simplifies the overall lineage of lineage(data_{final}). As part of the execution of the simplification process, the data lineage optimizing apparatus 100 determines the simplicity (via calculating a transform complexity as detailed infra) within the transformations of the process(source) 134, thereby allowing the process(source) 134 to be easily mimicked or moved to process(intermediate) 132. Accordingly, a simplified data lineage graph 140 is generated with the process(intermediate) 132 directly transforming the source dataset 126 into data_{final} 122 as shown along the data path (1) while eliminating the process(source) 134.

A more complex variation of this scenario is where the process(source) 134 involves intricate transformations as represented in the graph 120. Moving such intricate transformations to process(intermediate) 132 may have other implications such as an inability to manage the intricate transformations/business logic over time due to lack of domain knowledge or other such factors. In this case, the simplification process may retain the lineage(data_{final}) as is, without any changes.

The processor 102 executes instructions 166 to execute an alteration process that identifies at least one alternate transformation that transforms a final dataset to a corresponding original dataset in the data lake 150 so that the alternate transformation has higher reliability than an original transformation that transformed the original dataset to the final dataset. Referring now to FIG. 1C, a data lineage graph 180 of a dataset, data_{final} 182, referred to as lineage(data_{final}) is illustrated. The lineage(data_{final}) includes an intermediate dataset, data_{intermediate} 184 from which the dataset, data_{final} 182 is generated. The intermediate dataset, data_{intermediate} 184 in turn is obtained through process(source) 192, which transforms the source dataset dataₐ with columns [01-06] into the intermediate dataset, data_{intermediate} 184.

There is another process being implemented in the data lake 150, process(source_alt) 196 that produces another dataset data_{intermediate_alt} 186. It is assumed in this scenario that process(source) 192 has a higher rate of failure compared to process(intermediate) 194. It is also assumed in this scenario that there is a high similarity score between columns of the dataset, data_{intermediate} 184 and data_{intermediate_alt} 186. By examining the lineage(data_{final}) and the query plan at each stage, the processor 102 generates a suggestion for process(intermediate) 194 to depend on data_{intermediate_alt} 186 instead of data_{intermediate} 184 by executing the instructions 166 thereby improving the overall reliability of process(intermediate) 194. Thus, the alternate transformation can remove an existing dataset from a data lineage and add one or more of a new dataset and a new operation to the data lineage.

The processor 102 executes instructions 168 to generate new abstract syntax trees (ASTs) corresponding to the execution of the first and alteration processes on the selected datasets. In an example, a compiler of the source code can generate the ASTs. The processor 102 executes instructions 170 to translate the ASTs into executable code that is implemented and modifies Extract, Transform, Load (ETL) or Extract, Load, Transform (ELT) processes for a specified task. The processor 102 executes the instructions 162 and 164 for the simplification and alteration processes iteratively on the selected datasets. In an example, the processor 102 is configured to execute the simplification and alteration processes based on temporal thresholds or other triggers, e.g., if the accuracy of results from the data lake 150 falls below an accuracy threshold. The iterative execution of the simplification and alteration processes over other additional datasets of the data lake 150 enables ongoing refinement and robustness, culminating in an optimized data architecture that is dependable and efficient for end-users and stakeholders.

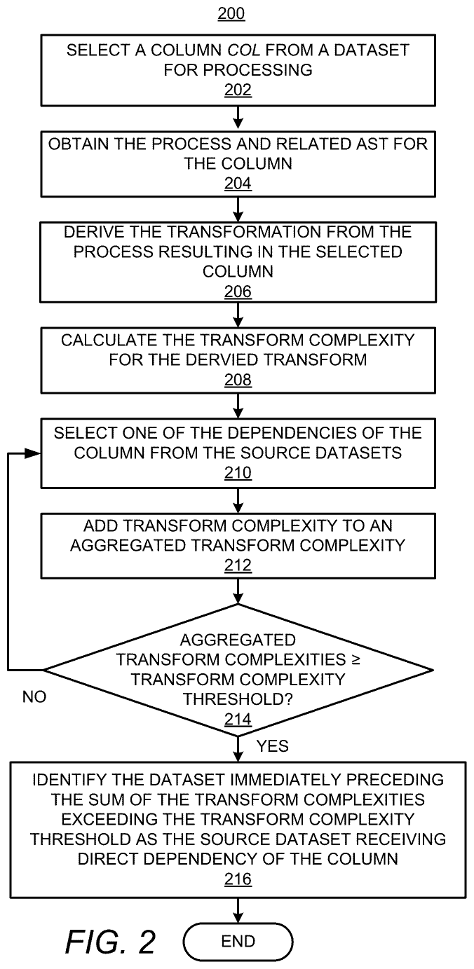

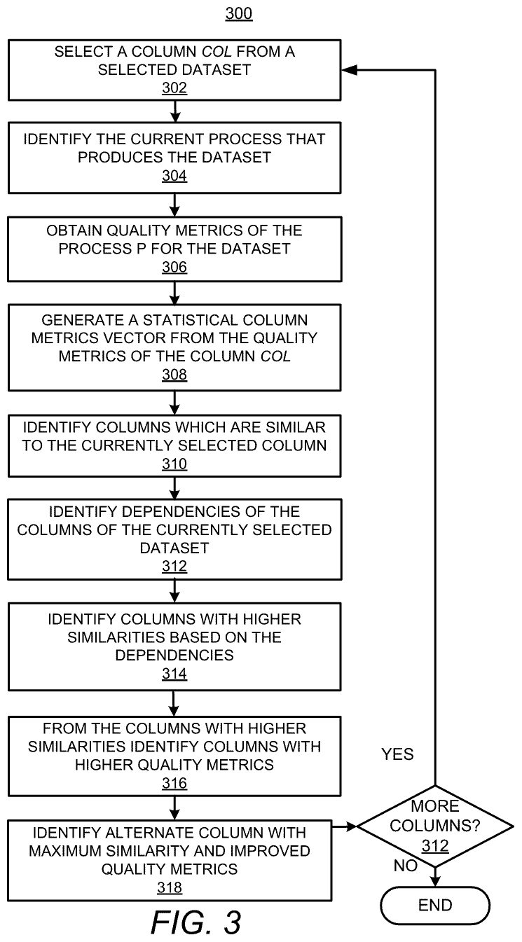

FIG. 2 shows a flowchart of a method 200 of simplifying the data lineage graphs of the selected datasets, e.g., the simplification process, in accordance with an embodiment of the present disclosure. FIG. 3 shows a flowchart of a method 300 of identifying alternate data paths/transformations, e.g., the alternation process, in accordance with an embodiment of the present disclosure. It should be understood that the methods 200, 300 respectively depicted in FIGS. 2 and 3 may include additional elements, and some of the elements described with respect to those methods 200, and 300 may be removed and/or modified without departing from the scopes of the present disclosure. The descriptions of FIGS. 2 and 3 are made with reference to the features shown in FIGS. 1A-1C for purposes of illustration.

With reference first to FIG. 2, at 202, the processor 102 selects a column col from a dataset δ for processing. At 204, the processor 102 obtains the process p producing the dataset δ and the AST_{ρ} corresponding to the process ρ, for example, from the data lake 150. At 206, the processor 102 derives the transform T_{col} within the process ρ resulting in the column col from the AST_{ρ}. At 208, the processor 102 calculates the transform complexity (TC) of the transform TC_{col∈δ/ρ} for col ∈δ.

Various transform complexities and scoring schemas can be pre-configured in the data lineage optimizing apparatus 100. A transformation can constitute different operations and the complexity of the transformation is obtained as an aggregate of the complexity of the operations involved in the transformation. For example, simple transforms such as re-naming of a column might have lower transform complexity values e.g., a transform complexity of ‘1’. A transformation of greater complexity such as a union operation can have a transform complexity of ‘3’ while a join operation has a higher transform complexity, e.g., ‘5’. A transformation which is a combination of multiple operations can have a transform complexity which is a combination of the transform complexity of the multiple operations. For example, a transform with two join operations can have a value of 5+5=10. Therefore, the transform complexity of the column is obtained as a cumulative score of the various operations involved in the transform derived at block 206.

At 210, the processor 102 selects one of the dependencies of the column col from the source datasets within the process ρ, for example, from AST_{ρ} corresponding to the process ρ is selected. At 212, the processor 102 adds the transform complexity of the selected dependency to aggregated transform complexity values accumulated iteratively for each of the columns col ∈ dataset δ. Therefore, the processor 102 aggregates the transform complexities associated with the dependencies at 212, and at 214, the processor 102 compares the aggregation with a transform complexity threshold at 214. If the transform complexity is greater than the transform complexity threshold (i.e., TC_{col ∈δ/ρ}>TC_{threshold}), the method 200 moves to 216, else the method 200 iterates back to 212 to select the next one of the dependencies. At each iteration the accumulated transform complexity is compared with the transform complexity threshold and the iterations cease when the transform complexity exceeds the transform complexity threshold indicating at that point that the transformation is too complex to be simplified. Therefore, at 216, the processor 102 identifies one of the datasets of the data lake processed in a step immediately preceding the sum of the transform complexities exceeding the transform complexity threshold as a source dataset directly receiving a dependency of the column col and the process terminates on the end block unless there are further columns to be processed similarly. Various selected datasets from the data lake 150 are processed accordingly for data lineage graph simplification for removing redundant operations. In addition, following 216, the method 200 may end.

Turning now to FIG. 3, the processor 102 executes the alteration process outlined in the method 300 simultaneously or in parallel with the simplification process described in the method 200. The processor 102 begins execution of the alteration process by initially executing the instructions at 302 for selecting a column col from a selected dataset δ. The alteration process is configured to select an alternate transformation that has higher reliability than the original transformation. Selection of the alternate transformation involves changing the data path from the current data path. As mentioned above, certain datasets, e.g., final datasets or destination datasets can be selected for optimization from the plurality of datasets 150-1, 150-2, . . . 150-n in the data lake 150.

At 304, the processor 102 identifies the current process or transformation p including one or more operations that produce the dataset δ. At 306, the processor 102 obtains quality metrics (Q_{ρ/δ}) of the process ρ for the dataset δ, such as but not limited to, reliability and consistency of the dataset, accuracy of the results, etc. At 308, the processor 102 generates a statistical column metrics vector by representing the values of the quality metrics (Q(ρ/δ) of the column col in a vector format.

At 310, the processor 102 identifies columns from the plurality of datasets 150-1, 150-2, . . . 150-n which are similar to the currently selected column col. Various similarity measures such as but not limited to cosine similarity, Euclidean distance, etc., can be used for identifying similar columns from other datasets. Again, the similarities can be obtained by representing the columns to be compared as vectors. The processor 102 identifies column dependencies for the column col at 312 from the columns of the source datasets (e.g., one or more of the plurality of datasets 150-1, 150-2, . . . 150-n) from which column col is derived. In an example, the column dependencies can be identified from the Abstract Syntax Trees (ASTs). From the column dependencies, the processor 102 identifies columns with the higher similarity (e.g., columns with top 10 similarity scores) at 314. From the columns with higher similarity, at 316, processor 102 identifies the columns that improve upon the metrics using, for example, the statistical column metrics vectors of the corresponding columns. The columns that have a greater quality score (e.g., the magnitude of the statistical column metrics vectors) than the currently selected column col can be identified.

From the columns identified at 316, the processor 102 selects an alternate column at 318. A column with the maximum similarity score which improves upon the quality metrics of the currently selected column is selected as the alternate column. At 320, the processor 102 determines if more columns of the selected dataset δ remain to be processed. If yes, the process returns to block 302 to select the next column. If no more columns remain for processing, the processor 102 may select a dataset, including a maximum number of columns selected at 318 as alternate columns of the currently selected dataset δ, as the alternate dataset.

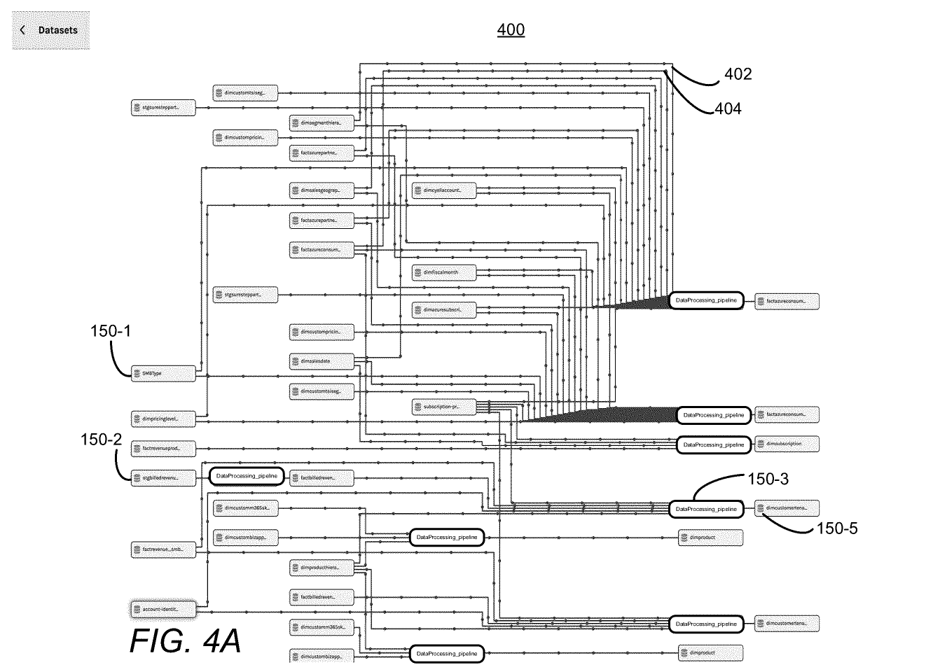

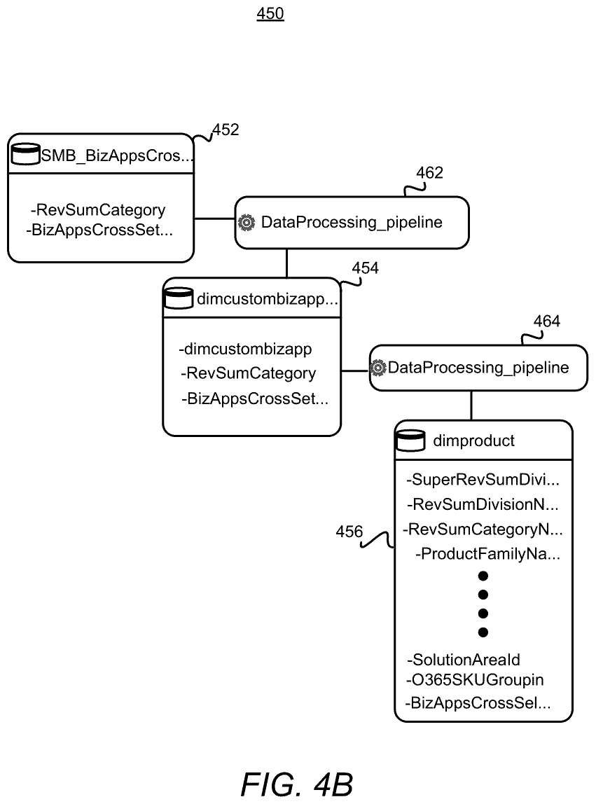

FIG. 4A shows an illustration 400 of a portion of a representation of the various datasets in a data lake in accordance with an embodiment of the present disclosure. In the various datasets represented, datasets 150-1 and 150-2, show examples of source datasets from which intermediate and final datasets are derived. The connections, e.g., 402, 404, . . . , etc., show the relationships between the various datasets. Dataset 150-3 shows an example of an intermediate dataset derived from one or more source datasets and from which a final dataset 150-5 is derived. The data lineage optimization apparatus 100, by executing the simplification process in accordance with the embodiments disclosed herein removes redundant intermediate sources (e.g., intermediate dataset 150-3) so that the data lineage graphs of the final datasets are simplified hence improving the efficiency of a database system. Furthermore, as seen from illustration 400, a final dataset may have multiple data paths through different intermediate datasets leading from a source dataset. The data lineage optimization apparatus 100, by executing the alteration process in accordance with the embodiments disclosed herein, determines from the various alternate data paths the most accurate data path. Therefore, execution of the first and alteration processes improves the efficiency and accuracy of the database system.

FIG. 4B shows an example data lineage graph 450 of a dataset in accordance with an embodiment of the present disclosure. The data lineage graph 450 includes a source dataset 452 and an intermediate dataset 454 derived from the source dataset 452 via a first transformation 462. The data lineage graph 450 also includes a final dataset 456 derived from the intermediate dataset 454 via a second transformation process 464. When processed by the data lineage optimization apparatus 100, the data lineage graph 450 can be optimized to delete the intermediate dataset 454 so that the final dataset 456, i.e., dimproduct dataset is directly derived from the source dataset 452. As part of the optimization, it can be appreciated that the data path is also altered so that only the first transformation 462 is retained while the second transformation process 464 is eliminated. When the alteration process is applied, the data path may be altered to include new transformations and/or new datasets in addition to or instead of just eliminating existing transformations and/or datasets.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A data lineage optimizing system comprising
a processor; and
a memory on which are stored machine-readable instructions that when executed by the processor, cause the processor to:
execute a simplification process that removes redundant data operations and simplifies a data lineage graph of a dataset in a data lake;
execute an alteration process that identifies at least one alternate transformation to transform an original dataset into at least one final dataset in the data lake,
wherein the at least one alternate transformation has superior quality metrics than an original transformation that transforms the original data set into the at least one final dataset; and
iteratively execute the simplification process and the alteration process on additional datasets of the data lake.

2. The data lineage optimizing system of claim 1, wherein the machine-readable instructions to iteratively execute the simplification process and the alteration process further cause the processor to:
execute the simplification process and the alteration process in parallel on the additional datasets of the data lake.

3. The data lineage optimizing system of claim 1, wherein the machine-readable instructions further cause the processor to:
generate new abstract syntax trees (ASTs) from the iteratively executed simplification and alteration processes.

4. The data lineage optimizing system of claim 3, wherein the machine-readable instructions further cause the processor to:
translate the new abstract syntax trees (ASTs) into executable code that modifies one or more of Extract, Transform, Load (ETL) or Extract, Load, Transform (ELT) processes for the data lake.

5. The data lineage optimizing system of claim 1, wherein the machine-readable instructions to execute the simplification process further cause the processor to:
calculate a transform complexity of a transformation used to generate at least one column of the dataset; and
extract dependencies of the at least one column of the dataset from an abstract syntax tree (AST) of the transformation.

6. The data lineage optimizing system of claim 5, wherein the machine-readable instructions to execute the simplification process further cause the processor to:
continue the calculation of the transform complexity and the extraction of dependencies for a plurality of columns including the at least one column of the dataset until a sum of the transform complexities of the plurality of columns exceeds a transform complexity threshold.

7. The data lineage optimizing system of claim 6, wherein the machine-readable instructions to execute the simplification process further cause the processor to:
identify one of the datasets of the data lake processed in a step immediately preceding the sum of the transform complexities exceeding the transform complexity threshold as a source dataset directly receiving a dependency of the dataset.

8. The data lineage optimizing system of claim 1, wherein to execute the alteration process that identifies the at least one alternate transformation, the machine-readable instructions further cause the processor to:
extract quality metrics of data generated by the original transformation and data generated by the alternate transformation.

9. The data lineage optimizing system of claim 8, the quality metrics include quality checks performed, a service level agreement guaranteed, and a frequency of fulfillment of the service level agreement.

10. The data lineage optimizing system of claim 8, wherein to execute the alteration process that identifies the at least one alternate transformation, the machine-readable instructions further cause the processor to:
generate statistical column metrics vectors for the at least one final dataset, and other datasets including the original dataset of the data lake; and
calculate similarities between the statistical column metrics vector of the final dataset and the statistical column metrics vectors of other datasets including the original dataset of the data lake.

11. The data lineage optimizing system of claim 10, wherein to calculate the similarities, the machine-readable instructions further cause the processor to:
calculate the similarities with one of Euclidean distance or cosine similarity measures.

12. The data lineage optimizing system of claim 10, wherein to identify the at least one alternate transformation, the machine-readable instructions further cause the processor to:
identify based at least on abstract syntax trees (ASTs) of the original transformation, column dependencies of the final dataset.

13. The data lineage optimizing system of claim 10, wherein to identify the at least one alternate transformation, the machine-readable instructions further cause the processor to:
select a transformation that maximizes the similarities and improves on the quality metrics of the original transformation as the alternate transformation.

14. The data lineage optimizing system of claim 13, wherein the alternate transformation removes an existing dataset from a data lineage of an original dataset and further adds one or more of a new dataset and a new operation to a data lineage of the original dataset.

15. A processor-executable method comprising:
executing, by a processor, a simplification process that removes redundant data operations and simplifies data lineage graphs of one or more final datasets of a data lake;
executing, by the processor, an alteration process that identifies at least one alternate transformation for transforming an original dataset to at least one final dataset of the one or more final datasets in the data lake,
wherein the at least one alternate transformation has superior quality metrics than an original transformation that transforms the original dataset to the at least one final dataset; and
iteratively executing, by the processor, the simplification process and the alteration process on additional datasets of the data lake.

16. The method of claim 15, wherein iteratively executing the simplification process and the alteration process further comprises:
serially executing by the processor, the simplification process, and the alteration process on the additional datasets of the data lake.

17. The method of claim 16, wherein serially executing the simplification process, and the alteration process further comprises:
replacing, by the processor, the original transformation with the at least one alternate transformation in the data lineage graph of the at least one final dataset via the execution of the alteration process.

18. A computer-readable medium on which is stored a plurality of instructions that when executed by a processor, cause the processor to:
execute an alteration process that identifies at least one alternate transformation that transforms an original dataset into a final dataset, wherein the original dataset and the final dataset as included in a data lake and the at least one alternate transformation has superior quality metrics than an original transformation that transforms the original data set to the final dataset;
execute a simplification process that simplifies a data lineage graph of the final dataset by removing one or more redundant data operations from the data lineage graph; and
iteratively execute the simplification process and the alteration process on additional datasets of the data lake.

19. The computer-readable medium of claim 18, wherein the instructions further cause the processor to:
generate new abstract syntax trees (ASTs) from the iteratively and parallelly executed first and alteration processes.

20. The computer-readable medium of claim 19, wherein the instructions further cause the processor to:
translate the new abstract syntax trees (ASTs) into executable code that modifies one or more of Extract, Transform, Load (ETL) or Extract, Load, Transform (ELT) processes of the data lake.
